(19) United States
(12) Patent Application Publication
(10) Pub. No.: US 2023/0014620 A1
(43) Pub. Date: Jan. 19, 2023

(54) MEASUREMENT DEVICE, MEASUREMENT METHOD, AND COMPUTER PROGRAM PRODUCT

(71) Applicant: Panasonic Intellectual Property Management Co., Ltd., Osaka (JP)

(72) Inventor: Shigeaki SAKURAZAWA, KANAGAWA KEN (JP)

(73) Assignee: Panasonic Intellectual Property Management Co., Ltd., Osaka (JP)

(21) Appl. No.: 17/861,994

(22) Filed: Jul. 11, 2022

(30) Foreign Application Priority Data
Jul. 13, 2021 (JP) 2021-115485

(51) Int. Cl. G01S 7/02; G01S 13/931

(52) U.S. Cl. CPC G01S 7/02; G01S 13/931; H01Q 1/3233

(57) ABSTRACT

A measurement device according to the present disclosure includes a memory and a processor coupled to the memory. The processor is configured to: transmit a distance-detecting radiowave from an antenna; detect a distance between the antenna and a vehicle based on a first reception radiowave received by the antenna, the first reception radiowave being a reception radiowave obtained by the antenna receiving a reflected wave of a distance-detecting radiowave reflected by the vehicle on which a communication system configured to transmit a measurement target radiowave is mounted; perform drive control on at least one of the antenna and the vehicle so that the detected distance reaches a set distance larger than 0; and derive, when the detected distance reaches the set distance, communication performance of the communication system based on a second reception radiowave that is the measurement target radiowave received by the antenna.

### CROSS-REFERENCE TO RELATED APPLICATIONS

This application is based upon and claims the benefit of priority from Japanese Patent Application No. 2021-115485, filed on Jul. 13, 2021, the entire contents of which are incorporated herein by reference.

### FIELD

Embodiments described herein relate generally to a measurement device, a measurement method, and a computer program product.

### BACKGROUND

Conventionally, there is known a system that receives, by an antenna, a radiowave emitted from a communication system mounted on a target such as a mobile phone or a vehicle and derives communication performance of the communication system on the basis of the reception radiowave that has been received (see, for example, JP No. 2019-505768 A). For example, a target is placed on a turntable or the like, and the target is rotated while a distance between an antenna and the target is kept constant, whereby a reception radiowave is acquired at each position around the target.

Communication systems mounted on targets have a plurality of wireless communication schemes such as long-distance wireless communication and short-distance wireless communication. In order to receive a radiowave transmitted from a communication system that transmits a radiowave by short-distance wireless communication or a radiowave of weak intensity, it is necessary to perform measurement by bringing an antenna close to a target. However, in the related art, there may be cases where the antenna collides with the target at the time of measurement. That is, in the related art, it is difficult to avoid contact between an antenna and a target to satisfactorily measure the communication performance of a communication system.

An object to be solved by the present disclosure is to provide a measurement device, a measurement method, and a computer program product, which can avoid contact between an antenna and a target to satisfactorily measure the communication performance of a communication system.

### SUMMARY

A measurement device according to the present disclosure includes a memory and a processor coupled to the memory. The processor is configured to: transmit a distance-detecting radiowave from an antenna; detect a distance between the antenna and a target based on a first reception radiowave received by the antenna, the first reception radiowave being a reflected wave of the distance-detecting radiowave reflected by the target on which a communication system configured to transmit a measurement target radiowave is mounted; perform drive control on at least one of the antenna and the target so that the detected distance reaches a set distance larger than 0; and derive, when the detected distance reaches the set distance, communication performance of the communication system based on a second reception radiowave, the second reception radiowave being the measurement target radiowave received by the antenna.

### BRIEF DESCRIPTION OF THE DRAWINGS

FIG. 1 is a schematic diagram illustrating an example of a measurement system according to an embodiment;

FIG. 2 is a functional block diagram illustrating an example of a measurement device;

FIG. 3 is a flowchart illustrating an example of a flow of information processing executed by the measurement device;

FIG. 4 is an explanatory diagram illustrating an example of a set distance;

FIG. 5 is an explanatory diagram illustrating an example of the set distance; and

FIG. 6 is a hardware configuration diagram illustrating an example of the measurement device.

### DETAILED DESCRIPTION

Hereinafter, embodiments of a measurement device, a measurement method, and a computer program product according to the present disclosure will be described with reference to the accompanying drawings.

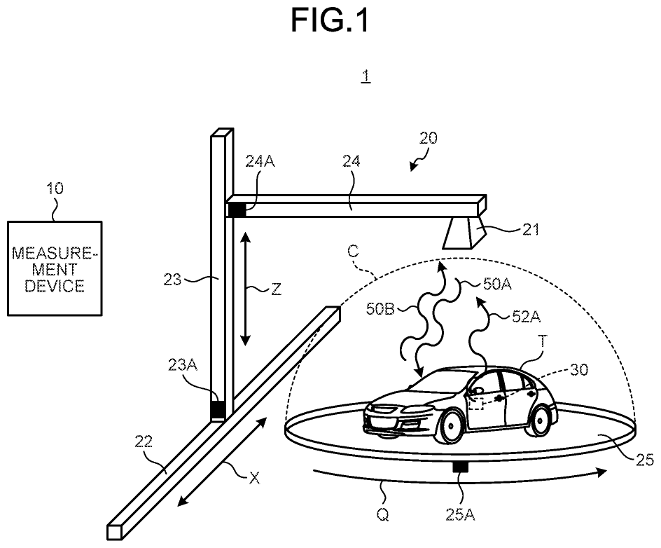

FIG. 1 is a schematic diagram illustrating an example of a measurement system 1 according to the present embodiment. The measurement system 1 includes a measurement device 10 and a measurement mechanism 20.

The measurement system 1 is a system for measuring communication performance of a communication system 30 mounted on a target.

The target is an object on which the communication system 30 is mounted. The target may be any object as long as the communication system 30 can be mounted thereon. Examples of the target include a vehicle T, a flying object such as an airplane, a ship, a structure such as a building, a mobile terminal, an electronic device such as a personal computer, or the like. In the present embodiment, a mode in which the target is a vehicle T will be described as an example.

The communication system 30 is a radiowave transmitter that wirelessly transmits a measurement target radiowave 52A. In other words, the communication system 30 is a radiowave transmitter that transmits the measurement target radiowave 52A into the air. Examples of the communication system 30 include a cordless telephone device, a wireless communication device such as a wireless fidelity (Wi-Fi) router, a radar transmitter, or the like. Examples of the communication system 30 also include various transmitters used for tracking, detection, communication, or the like.

The measurement target radiowave 52A is a radiowave wirelessly transmitted from the communication system 30. The measurement target radiowave 52A is a radiowave to be measured in the measurement system 1 of the present embodiment. The measurement target radiowave 52A may be any of a millimeter wave, a microwave, an ultra-shortwave, a short wave, a medium wave, and a long wave. The millimeter wave is a radiowave in the millimeter wave frequency band of a frequency band greater than or equal to 26 GHz. The millimeter wave is used for a mobile communication system such as 5G (5th generation mobile communication system), autonomous driving technology of the vehicle T, advanced driver assistance system (ADAS) technology, and the like. The radiowaves used in the ADAS technology include, for example, radar.

For the measurement target radiowave 52A transmitted from the communication system 30, various wireless communication schemes such as long-distance wireless communication of several hundred meters to several kilometers used in mobile communication systems and the like and short-distance wireless communication up to about 100 m are used. For example, for long-distance wireless communication, a measurement target radiowave 52A having a specific frequency and a specific strong intensity is used. Furthermore, for example, for short-distance wireless communication, a measurement target radiowave 52A having a specific frequency and a specific weak intensity is used. A strong intensity means an intensity equal to or greater than a predetermined threshold value. A weak intensity means an intensity less than a predetermined threshold value.

In the present embodiment, a mode in which the communication system 30 is mounted in the vehicle T, as an example of a target, will be described as an example.

The measurement mechanism 20 is a mechanism for receiving, by an antenna 21, the measurement target radiowave 52A transmitted from the communication system 30 mounted on the vehicle T. The measurement mechanism 20 is capable of receiving the measurement target radiowave 52A at every position in all directions of the vehicle T with at least a part thereof being movable.

Specifically, the measurement mechanism 20 includes an antenna 21, a support 22, a support 23, and a support 24.

The antenna 21 is a device that wirelessly receives a radiowave and wirelessly transmits a radiowave. In other words, the antenna 21 emits a radiowave into the air and receives a radiowave propagated by the air.

The antenna 21 is supported by the support 24. The support 24 is a rod-shaped member. The support 24 supports the antenna 21 at one end in the longitudinal direction, and the other end thereof is supported by the support 23. In the present embodiment, a mode in which the support 24 is disposed so that the longitudinal direction of the support 24 substantially coincides with a direction intersecting the vertical direction will be described as an example.

The support 23 is a rod-shaped member. In the present embodiment, a mode in which the support 23 is disposed so that the longitudinal direction of the support 23 substantially coincides with the vertical direction will be described as an example. One end of the support 23 in the longitudinal direction is supported by the support 22. The support 22 is a rod-shaped member disposed on the ground or the like. In the present embodiment, a mode in which the longitudinal direction of the support 22 substantially coincides with the horizontal direction will be described as an example.

A support 25 is a member that supports the vehicle T. In the present embodiment, the support 25 is a disk-shaped member. In the present embodiment, an example will be described in which the disk face of the support 25 is disposed in a direction along the horizontal direction. A drive unit 25A is provided at the center of the circle of the support 25. The drive unit 25A is driven under the control by the measurement device 10 described later. With the drive unit 25A driven, the support 25 rotates about the center of the circle by every predetermined angle (in the direction of arrow Q). As the support 25 rotates, the vehicle T placed on the support 25 rotates (in the direction of arrow Q).

The support 23 is provided with a drive unit 23A. The support 24 is provided with a drive unit 24A. The drive unit 23A and the drive unit 24A are driven under the control by the measurement device 10 described later. With the drive unit 23A driven, the support 23 moves along the longitudinal direction (direction of arrow X) of the support 22. With the drive unit 24A driven, the support 24 moves along the longitudinal direction (direction of arrow Z) of the support 23.

The antenna 21 supported by the support 24 is movably supported, with respect to the vehicle T, in a direction approaching or separating in the vertical direction and in a direction approaching or separating from a direction intersecting the vertical direction by driving of the drive unit 23A and the drive unit 24A.

That is, the antenna 21 is supported so as to be movable between the apex of a hemisphere C with the vehicle T as the center of the sphere and the peripheral edge of the hemisphere C by driving of the drive unit 23A and the drive unit 24A. Moreover, the antenna 21 is supported so that the diameter of the hemisphere C can be modified.

Next, the measurement device 10 will be described. The measurement device 10 is a device that measures the communication performance of the communication system 30 on the basis of the measurement target radiowave 52A received by the antenna 21.

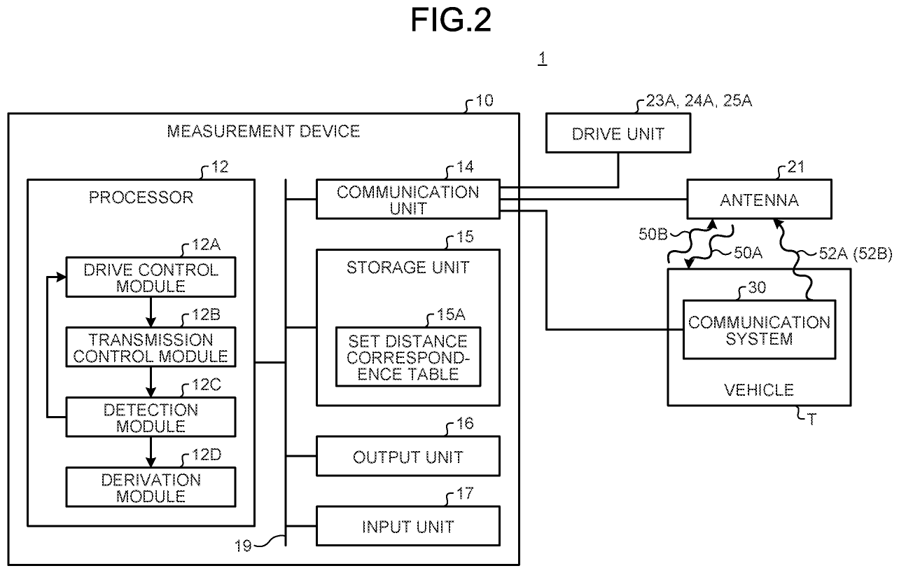

FIG. 2 is a functional block diagram illustrating an example of the measurement device 10. In FIG. 2, electrical components included in the measurement system 1 other than the measurement device 10 are also illustrated.

The measurement device 10 includes a processor 12, a communication unit 14, a storage unit 15, an output unit 16, and an input unit 17. The processor 12, the communication unit 14, the storage unit 15, the output unit 16, and the input unit 17 are communicably connected via a bus 19, for example.

The communication unit 14 is communicably connected with the drive unit 23A, the drive unit 24A, the drive unit 25A, and the antenna 21. In the present embodiment, a mode in which the communication unit 14 is communicably connected with each of the drive unit 23A, the drive unit 24A, the drive unit 25A, and the antenna 21 by wire will be described as an example. Furthermore, in the present embodiment, a mode in which the communication unit 14 is communicably connected to the communication system 30 by wire will be described as an example.

The storage unit 15 stores various types of information. The output unit 16 outputs various types of information. The output unit 16 is, for example, a display that displays an image, a speaker that outputs sound, or the like. Note that the output unit 16 may have a communication function of communicating with an external information processing device via a network or the like. With the communication function provided, the output unit 16 can transmit various types of information to an external information processing device. The input unit 17 receives operation input by a user. The input unit 17 is, for example, a keyboard, a pointing device, a touch panel, or the like.

The processor 12 executes various types of information processing. In the present embodiment, the processor 12 includes a drive control module 12A, a transmission control module 12B, a detection module 12C, and a derivation module 12D. Some or all of the drive control module 12A, the transmission control module 12B, the detection module 12C, and the derivation module 12D may be implemented by causing a processing device such as a central processing unit (CPU) to execute a program, that is, implementation by software, may be implemented by hardware such as an integrated circuit (IC), or may be implemented by using software and hardware in combination. Furthermore, at least one of the drive control module 12A, the transmission control module 12B, the detection module 12C, and the derivation module 12D may be mounted on an external information processing device communicably connected with the measurement device 10 via a network or the like.

The drive control module 12A performs drive control on at least one of the antenna 21 and the vehicle T. The drive control means to control to move the position of at least one of the antenna 21 and the vehicle T in the real space. In the present embodiment, a mode of performing drive control to move the position of the antenna 21 will be described as an example.

Specifically, the drive control module 12A performs drive control on the drive unit 23A, the drive unit 24A, and the drive unit 25A. For example, the drive control module 12A drives the drive unit 23A, the drive unit 24A, and the drive unit 25A so that the antenna 21 is sequentially disposed in each of regions obtained by dividing the outer periphery of the hemisphere C (see FIG. 1) centered on the vehicle T into a plurality of regions.

Specifically, the drive control module 12A performs drive control on the antenna 21 in a direction approaching the vehicle T or a direction away from the vehicle T by the drive control of the drive unit 23A and the drive unit 24A. Then, the drive control module 12A controls the drive unit 25A every time the position of the antenna 21 is controlled to move to a next measurement position between the apex of the hemisphere C and the peripheral edge of the hemisphere C. Under the control by the drive unit 25A, the drive control module 12A rotationally drives the vehicle T placed on the support 25 at every predetermined rotation angle.

In the measurement device 10, every time the antenna 21 is moved to a next measurement position by the drive control by the drive control module 12A and the vehicle T placed on the support 25 is rotationally driven at a predetermined rotation angle, the communication performance of the communication system 30 is derived using a second reception radiowave 52B of the measurement target radiowave 52A received by the antenna 21. That is, the measurement device 10 is configured to be capable of acquiring the second reception radiowave 52B received in each of the regions obtained by dividing the outer periphery into a plurality of regions along the outer periphery of the hemisphere C centered on the vehicle T. In other words, the measurement device 10 is configured to be capable of acquiring the second reception radiowave 52B received at every position in all directions of the vehicle T.

The transmission control module 12B controls the start and stop of transmission of the measurement target radiowave 52A from the communication system 30.

The transmission control module 12B transmits a transmission start signal indicating the start of transmission of the measurement target radiowave 52A to the communication system 30 via the communication unit 14. The communication system 30 that has received the transmission start signal of the measurement target radiowave 52A starts to wirelessly transmit the measurement target radiowave 52A. The transmission control module 12B further transmits a transmission stop signal indicating the stop of transmission of the measurement target radiowave 52A to the communication system 30 via the communication unit 14. The communication system 30 that has received the transmission stop signal of the measurement target radiowave 52A stops transmission of the measurement target radiowave 52A.

Furthermore, the transmission control module 12B causes the antenna 21 to transmit a distance-detecting radiowave 50A.

The distance-detecting radiowave 50A is a radiowave used for detection of the distance between the antenna 21 and the vehicle T. In the present embodiment, a mode in which the distance-detecting radiowave 50A is a modulated wave will be described as an example. For example, the transmission control module 12B outputs a transmission signal of the distance-detecting radiowave 50A representing a pulse wave of a predetermined specific frequency to the antenna 21 via the communication unit 14. When receiving the transmission signal from the transmission control module 12B via the communication unit 14, the antenna 21 starts transmitting the distance-detecting radiowave 50A represented by the transmission signal.

The detection module 12C detects the distance between the antenna 21 and the vehicle T on the basis of a first reception radiowave 50B received by the antenna 21.

The first reception radiowave 50B is a reception radiowave obtained by the antenna 21 receiving a reflected wave of the distance-detecting radiowave 50A transmitted from the antenna 21 and reflected by the vehicle T.

The detection module 12C calculates the distance between the antenna 21 and the vehicle T on the basis of the distance-detecting radiowave 50A and the first reception radiowave 50B.

For example, the detection module 12C derives a time from transmission of the distance-detecting radiowave 50A to reception of the first reception radiowave 50B that is a reflected wave of the distance-detecting radiowave 50A by the vehicle T by using a known time domain scheme or the like. Then the detection module 12C calculates the distance between the vehicle T and the antenna 21 using the derived time and the speed of the radiowave.

Note that the transmission control module 12B may cause the antenna 21 to transmit a modulated wave by a frequency modulated continuous wave (FMCW) scheme as the distance-detecting radiowave 50A. In this case, the detection module 12C generates an intermediate frequency (IF) signal from the distance-detecting radiowave 50A and the first reception radiowave 50B and performs known signal processing on the IF signal and thereby calculates the distance. For example, the detection module 12C derives a frequency spectrum by performing analog/digital (AD) conversion and further performing Fourier transform (FFT) on the IF signal. Then the detection module 12C calculates the distance between the vehicle T and the antenna 21 from the derived frequency spectrum.

Alternatively, the detection module 12C may calculate the distance between the antenna 21 and the vehicle T on the basis of the difference between the intensity of the distance-detecting radiowave 50A and the intensity of the first reception radiowave 50B. For example, the detection module 12C stores the distance corresponding to the difference between the amplitude intensity of the distance-detecting radiowave 50A and the amplitude intensity of the first reception radiowave 50B in the storage unit 15 in advance in association with each other. Furthermore, the detection module 12C may derive the distance between the antenna 21 and the vehicle T by reading, from the storage unit 15, a distance corresponding to a difference between the amplitude intensity of the distance-detecting radiowave 50A and the amplitude intensity of the first reception radiowave 50B.

The drive control module 12A performs drive control on at least one of the antenna 21 and the vehicle T so that the distance detected by the detection module 12C reaches a set distance larger than 0. In the present embodiment, as described above, a mode in which the drive control module 12A performs drive control on the drive unit 23A and the drive unit 24A and thereby performs drive control on the position of the antenna 21 will be described as an example.

The set distance is a target distance between the vehicle T and the antenna 21 at the time of measurement. As described above, various wireless communication schemes such as long-distance wireless communication and short-distance wireless communication are used for the measurement target radiowave 52A transmitted from the communication system 30. For example, for long-distance wireless communication, a measurement target radiowave 52A having a specific frequency and a specific intensity is used. For short-distance wireless communication, a measurement target radiowave 52A having a specific frequency and a specific weak intensity is used.

At the time of measuring the communication performance of the measurement target radiowave 52A for short-distance wireless communication, it is necessary to dispose the antenna 21 at a position closer to the vehicle T. On the other hand, when the communication performance of the measurement target radiowave 52A for long-distance wireless communication is measured, the antenna 21 needs to be disposed at a position far from vehicle T. Therefore, as a set distance, a target distance for measuring the communication performance corresponding to the wireless communication scheme is determined. Note that, as the set distance, a value larger than 0 is set in advance from the perspective of avoiding a collision between the antenna 21 and the vehicle T.

In the present embodiment, the drive control module 12A performs drive control on at least one of the antenna 21 and the vehicle T so that the detected distance reaches a set distance corresponding to the wireless communication scheme of the measurement target radiowave 52A transmitted from the communication system 30. First, the drive control module 12A acquires a set distance corresponding to the wireless system of the measurement target radiowave 52A.

For example, the drive control module 12A acquires the wireless communication scheme of the measurement target radiowave 52A from the communication system 30 via the communication unit 14. Alternatively, for example, the drive control module 12A may acquire the wireless communication scheme input by a user from the input unit 17.

The drive control module 12A further reads a set distance corresponding to the acquired wireless communication scheme from the storage unit 15 to acquire a set distance corresponding to the wireless communication scheme of the measurement target radiowave 52A.

For example, a set distance correspondence table 15A may be stored in advance in the storage unit 15. The set distance correspondence table 15A is a table in which the wireless communication scheme and the set distance are associated with each other. Note that the data format of the set distance correspondence table 15A may be a database or the like and is not limited to tables. Specifically, the set distance correspondence table 15A is a table in which wireless communication schemes and set distances representing target distances for measuring the communication performance depending on the wireless communication schemes are associated in advance. Specifically, in the set distance correspondence table 15A, for example, a set distance indicating N mm is registered in advance in association with long-distance wireless communication that is a wireless communication scheme. N is an integer greater than 0. In addition, in the set distance correspondence table 15A, for example, a set distance indicating L mm is registered in advance in association with short-distance wireless communication that is a wireless communication scheme. L is an integer greater than 0 and less than N.

The drive control module 12A is only required to acquire the set distance corresponding to the wireless communication scheme of the measurement target radiowave 52A by reading a set distance corresponding to the acquired wireless communication scheme from the storage unit 15.

Note that the wireless communication schemes and the set distances registered in the set distance correspondence table 15A may be modifiable in accordance with, for example, an operation instruction to the input unit 17 by a user.

Alternatively, the user may input a desired set distance by operating the input unit 17. In this case, the drive control module 12A is only required to acquire the set distance from the input unit 17. By acquiring the set distance from the input unit 17, the drive control module 12A can acquire any set distance desired by the user. However, as described above, it is essential that the set distance be a value exceeding 0.

The drive control module 12A performs drive control on at least one of the antenna 21 and the vehicle T so that the distance between the antenna 21 and the vehicle T detected by the detection module 12C reaches the acquired set distance.

In the present embodiment, the drive control module 12A performs drive control on the antenna 21 in a direction approaching the vehicle T or a direction away from the vehicle T by the drive control of the drive unit 23A and the drive unit 24A. For example, the drive control module 12A moves the antenna 21 to a predetermined position in the real space by drive control of the drive unit 23A and the drive unit 24A.

Then the drive control module 12A acquires, from the detection module 12C, the distance between the antenna 21 and the vehicle T detected from the distance-detecting radiowave 50A transmitted from the antenna 21 at that position and the first reception radiowave 50B that is a reflected wave of the distance-detecting radiowave 50A reflected by the vehicle T and received by the antenna 21 at that position.

In a case where the distance detected by the detection module 12C is less than the set distance, the drive control module 12A stops the drive control of the antenna 21 and the vehicle T. In the present embodiment, in a case where the distance detected by the detection module 12C is less than the set distance, the drive control module 12A stops the drive control of the drive unit 23A and the drive unit 24A, thereby performing stop control to stop the movement of the antenna 21.

In a case where the distance detected by the detection module 12C is less than the set distance, the drive control module 12A stops the drive control of the antenna 21 and the vehicle T, and thus contact and collision between the antenna 21 and the vehicle T are avoided.

Moreover, in a case where the distance detected by the detection module 12C is less than the set distance, the drive control module 12A performs drive control on at least one of the antenna 21 and the vehicle T so that the distance between the antenna 21 and the vehicle T increases. In the present embodiment, the drive control module 12A moves the antenna 21 in a direction away from the vehicle T by controlling the drive unit 23A and the drive unit 24A.

In a case where the distance detected by the detection module 12C is less than the set distance, the drive control module 12A is only required to perform at least one of stop control of the driving of the antenna 21 and the vehicle T and drive control of increasing the distance between the antenna 21 and the vehicle T. In the present embodiment, in a case where the distance detected by the detection module 12C is less than the set distance, the drive control module 12A performs drive control to move the antenna 21 in a direction away from the vehicle T after stopping the drive control of the antenna 21.

In a case where the distance detected by the detection module 12C exceeds the set distance, the drive control module 12A drives at least one of the antenna 21 and the vehicle T so that the distance between the antenna 21 and the vehicle T decreases. In the present embodiment, in a case where the distance detected by the detection module 12C exceeds the set distance, the drive control module 12A performs drive control to move the antenna 21 in a direction approaching the vehicle T by performing drive control on the drive unit 23A and the drive unit 24A.

In a case where the distance detected by the detection module 12C reaches the set distance, the derivation module 12D derives the communication performance of the communication system 30 on the basis of the second reception radiowave 52B that is the measurement target radiowave 52A received by the antenna 21.

For example, the derivation module 12D derives, as the communication performance, information in which information representing the second reception radiowave 52B that has been acquired is associated with position information of the antenna 21 in the real space at the time of acquisition of second reception radiowave 52B. As the position of the antenna 21 in the real space, a position on the outer surface of the hemisphere C of the antenna 21 derived by the control of the drive unit 23A, the drive unit 24A, and the drive unit 25A by the drive control module 12A may be used.

Note that the derivation module 12D is only required to use at least one of the amplitude, the wavelength, the period, and the speed of the second reception radiowave 52B that have been acquired as the information representing the second reception radiowave 52B.

Next, an example of a flow of information processing executed by the measurement device 10 of the present embodiment will be described.

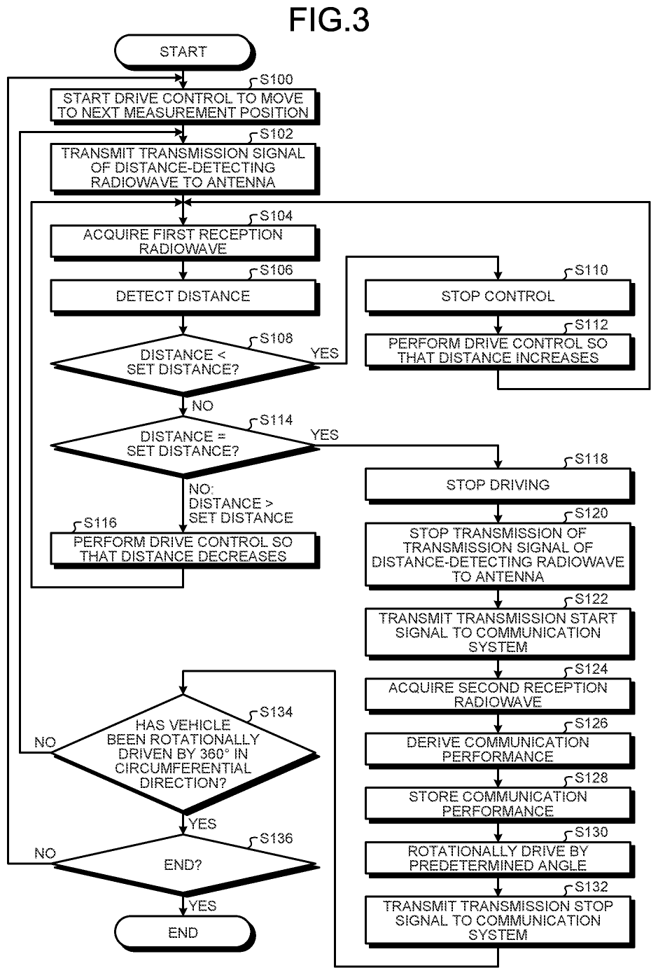

FIG. 3 is a flowchart illustrating an example of a flow of information processing executed by the measurement device 10. In a state immediately before the flowchart illustrated in FIG. 3 is executed, description will be given on the premise that the antenna 21 and the communication system 30 are in a state of not transmitting radiowaves. The description is also based on the premise that, before execution of the flowchart illustrated in FIG. 3, the processor 12 has acquired the set distance corresponding to the wireless communication scheme of the measurement target radiowave 52A in advance.

The drive control module 12A controls the movement of the antenna 21 to a next measurement position (step S100). The drive control module 12A drives and controls the drive unit 23A and the drive unit 24A to move the position of the antenna 21 on the outer periphery of the hemisphere C (see FIG. 1) centered on the vehicle T to the next measurement position between the apex of the hemisphere C on the outer periphery and the peripheral edge of the hemisphere C.

The transmission control module 12B transmits the transmission signal of the distance-detecting radiowave 50A to the antenna 21 via the communication unit 14 (step S102). The antenna 21 that has received the transmission signal of the distance-detecting radiowave 50A starts transmitting the distance-detecting radiowave 50A.

The detection module 12C acquires the first reception radiowave 50B that is a reflected wave of the distance-detecting radiowave 50A reflected by the vehicle T and received by the antenna 21 (step S104). The detection module 12C acquires the first reception radiowave 50B from the antenna 21 via the communication unit 14.

The detection module 12C detects the distance between the antenna 21 and the vehicle T on the basis of the distance-detecting radiowave 50A and the first reception radiowave 50B acquired in step S104 (step S106).

The drive control module 12A determines whether or not the distance detected in step S106 is less than the set distance (step S108). If it is determined that the distance detected in step S106 is less than the set distance (step S108: Yes), the process proceeds to step S110.

In step S110, the drive control module 12A stops the drive control of the drive unit 23A and the drive unit 24A and thereby performs stop control of stopping the movement of the antenna 21 (step S110). The processing in step S110 avoids contact or collision between the antenna 21 and the vehicle T.

Then the drive control module 12A performs drive control on the antenna 21 so that the distance between the antenna 21 and the vehicle T increases (step S112). In step S112, the drive control module 12A controls the drive unit 23A and the drive unit 24A, thereby moving the antenna 21 in a direction away from the vehicle T. Then, the process returns to step S104 described above.

On the other hand, if it is determined that the distance detected in step S106 is equal to or greater than the set distance in step S108 (step S108: No), the drive control module 12A proceeds to step S114. In step S114, the drive control module 12A determines whether or not the distance detected in step S106 reaches the set distance (step S114).

If a negative determination is made in step S114 (step S114: No), the process proceeds to step S116. That is, if the distance detected in step S106 is larger than the set distance, the drive control module 12A makes a negative determination in step S114 (step S114: No).

In step S116, the drive control module 12A performs drive control on the antenna 21 so that the distance between the antenna 21 and the vehicle T decreases (step S116). The drive control module 12A performs drive control to move the antenna 21 in a direction approaching the vehicle T by performing drive control on the drive unit 23A and the drive unit 24A. Then, the process returns to step S104 described above.

On the other hand, if an affirmative determination is made in step S114 (step S114: Yes), the process proceeds to step S118. If the distance detected in step S106 reaches the set distance, the drive control module 12A makes an affirmative determination in step S114 (step S114: Yes).

In step S118, the drive control module 12A stops the drive control of the drive unit 23A and the drive unit 24A and thereby performs stop control of stopping the movement of the antenna 21 (step S118). By the processing of step S118, a state in which the distance between the antenna 21 and the vehicle T reaches the set distance is maintained.

Next, the transmission control module 12B stops transmission of the transmission signal of the distance-detecting radiowave 50A to the antenna 21 (step S120). The antenna 21, to which the transmission of the transmission signal of the distance-detecting radiowave 50A has been stopped, stops transmission of the distance-detecting radiowave 50A.

Next, the transmission control module 12B transmits the transmission start signal indicating the start of transmission of the measurement target radiowave 52A to the communication system 30 (step S122). The communication system 30 that has received the transmission start signal starts transmission of the measurement target radiowave 52A.

The derivation module 12D acquires the second reception radiowave 52B that is the measurement target radiowave 52A received by the antenna 21 (step S124). The derivation module 12D acquires the second reception radiowave 52B from the antenna 21 via the communication unit 14.

The derivation module 12D derives the communication performance of the communication system 30 on the basis of the second reception radiowave 52B acquired in step S214 (step S126). Then the derivation module 12D stores the communication performance derived in step S126 in the storage unit 15 (step S128).

Next, the drive control module 12A controls the drive unit 25A and thereby rotationally drives the vehicle T placed on the support 25 at a predetermined rotation angle (step S130). Then, the process proceeds to step S132. The predetermined rotation angle may be determined in advance. The predetermined rotation angle may be, for example, 5°, 10°, or 30°, but it is not limited thereto. The predetermined rotation angle may be set and modifiable by an operation instruction or the like to the input unit 17 by a user.

In step S132, the transmission control module 12B transmits, to the communication system 30, the transmission stop signal indicating the stop of transmission of the measurement target radiowave 52A (step S132). The communication system 30 that has received the transmission stop signal stops transmission of the measurement target radiowave 52A. Note that the processing of step S130 may be executed after the processing of step S132.

Next, the processor 12 determines whether or not the vehicle T placed on the support 25 has been rotationally driven by 360° in the circumferential direction (see the direction of arrow Q in FIG. 1) in a state where the antenna 21 is positioned at the measurement position between the apex and the peripheral edge in the hemisphere C that has been adjusted in step S100 (step S134).

If a negative determination is made in step S134 (step S134: No), the process returns to step S102 described above.

If an affirmative determination is made in step S134 (step S134: Yes), the process proceeds to step S136.

In step S136, the processor 12 determines whether or not to end the measurement processing (step S136). For example, the processor 12 makes the determination in step S136 by determining whether or not measurement of the communication performance of the communication system 30 at measurement positions in all directions centered on the vehicle T has been completed. If a negative determination is made in step S136 (step S136: No), the process returns to step S100 described above. If an affirmative determination is made in step S136 (step S136: Yes), the present routine is ended.

As described above, the measurement device 10 of the present embodiment includes the transmission control module 12B, the detection module 12C, and the drive control module 12A. The transmission control module 12B causes the antenna 21 to transmit the distance-detecting radiowave 50A. The detection module 12C detects the distance between the antenna 21 and the vehicle T on the basis of the first reception radiowave 50B received by the antenna 21. The first reception radiowave 50B is a reception radiowave obtained by the antenna 21 receiving a reflected wave of the distance-detecting radiowave 50A reflected by the vehicle T on which the communication system 30 that transmits the measurement target radiowave 52A is mounted. The drive control module 12A performs drive control on at least one of the antenna 21 and the vehicle T so that the detected distance reaches the set distance larger than 0. In a case where the detected distance reaches the set distance, the derivation module 12D derives the communication performance of the communication system 30 on the basis of the second reception radiowave 52B that is the measurement target radiowave 52A received by the antenna 21.

As described above, in the measurement device 10 of the present embodiment, the drive control module 12A performs drive control on at least one of the antenna 21 and the vehicle T so that the distance between the antenna 21 and the vehicle T detected by the detection module 12C reaches the set distance larger than 0. Furthermore, in a case where the distance between the antenna 21 and the vehicle T reaches the set distance, the derivation module 12D derives the communication performance of the communication system 30 on the basis of the second reception radiowave 52B received by the antenna 21 positioned at the set distance.

Therefore, in the measurement device 10 of the present embodiment, it is possible to avoid contact or collision between the antenna 21 and the vehicle T to satisfactorily measure the communication performance of the communication system 30.

Therefore, the measurement device 10 of the present embodiment can avoid contact between the antenna 21 and the target (vehicle T) to satisfactorily measure the communication performance of the communication system 30.

Moreover, the drive control module 12A of the measurement device 10 of the present embodiment performs drive control on at least one of the antenna 21 and the vehicle T so that the detected distance reaches the set distance corresponding to the wireless communication scheme of the measurement target radiowave 52A.

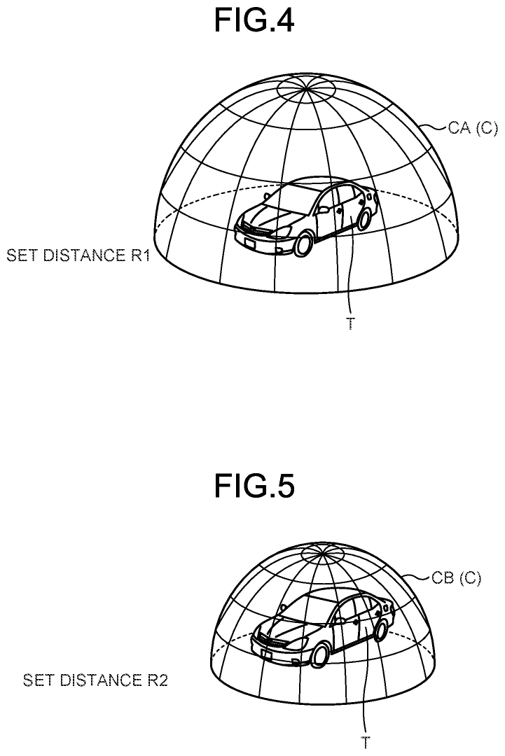

FIGS. 4 and 5 are explanatory diagrams of examples of a set distance. FIG. 4 is a diagram illustrating an example of a hemisphere CA representing a group of measurement positions in a case where the set distance is Rl. The hemisphere CA is an example of the hemisphere C. FIG. 5 is a diagram illustrating an example of a hemisphere CB representing a group of measurement positions in a case where the set distance is R2. The measurement distance R2 is shorter than the measurement distance R1. The hemisphere CB is an example of the hemisphere C.

As illustrated in FIGS. 4 and 5, in the measurement device 10 of the present embodiment, the set distance between the antenna 21 and the vehicle T can be made variable. Therefore, the measurement device 10 of the present embodiment can adjust the distance between the antenna 21 and the vehicle T to a set distance corresponding to a wireless communication scheme.

Furthermore, the measurement device 10 of the present embodiment derives the communication performance of the communication system 30 on the basis of the second reception radiowave 52B received by the antenna 21 in a state where a contact or collision with the vehicle T is suppressed and the distance to the vehicle T has been adjusted to the set distance. Therefore, in addition to the above effects, the measurement device 10 of the present embodiment can measure the communication performance of the communication system 30 with high accuracy while avoiding contact between the antenna 21 and the vehicle T.

Note that, in FIGS. 4 and 5, as a diagram schematically illustrating the shape of the hemisphere C, the hemisphere C in which a cross section parallel to the peripheral edge of the hemisphere C is a substantially perfect circle is illustrated as an example. However, since the hemisphere C representing a group of measurement positions by the antenna 21 is actually a group of measurement positions separated from the outer surface of the vehicle T by a set distance, it goes without saying that the shape extends along the outer shape of the vehicle T.

Moreover, the measurement device 10 of the present embodiment detects the distance between the antenna 21 and the vehicle T on the basis of the first reception radiowave 50B that is a reflected wave, by the vehicle T, of the distance-detecting radiowave 50A and received by the antenna 21. Furthermore, the measurement device 10 derives the communication performance of the communication system 30 on the basis of the second reception radiowave 52B of the measurement target radiowave 52A received by the antenna 21.

As described above, the measurement device 10 of the present embodiment detects the distance and derives the communication performance using the antenna 21. Therefore, the measurement device 10 of the present embodiment can avoid contact between the antenna 21 and the vehicle T and measure the communication performance of the communication system 30 with high accuracy with a simple configuration without being separately provided with a device for distance detection.

Note that, in the present embodiment, a mode in which the measurement device 10 performs drive control to move the position of the antenna 21 with respect to the vehicle T by driving and controlling the drive unit 23A and the drive unit 24A has been described as an example. However, the measurement device 10 is only required to perform drive control to move the position in the real space of at least one of the vehicle T and the antenna 21 and is not limited to the mode of performing drive control on the antenna 21. For example, the drive unit 25A provided to the support 25 is caused to function as a drive unit that rotationally drives the support 25 and moves the position of the support 25 in the real space. In this case, the measurement device 10 can control the position of the support 25 in the real space and drive and control the position of the vehicle T placed on the support 25 by performing drive control on the drive unit 25A. That is, the measurement device 10 may move the position of at least one of the antenna 21 and the vehicle T in the real space by performing drive control on the drive unit 23A, the drive unit 24A, and the drive unit 25A.

Furthermore, in the present embodiment, the case where the target on which the communication system 30 is mounted is the vehicle T has been described as an example. However, the target is not limited to the vehicle T. As described above, the target may be any object on which the communication system 30 is mounted and may be a flying object such as an airplane, a ship, a structure such as a building, a mobile terminal, or an electronic device such as a personal computer. The measurement device 10 of the present embodiment is particularly usefully applied to derive the communication performance of the communication system 30 mounted on an object having a non-uniform outer shape, a precision object weak against impact, or the like.

Next, an example of a hardware configuration of the measurement device 10 of the above embodiment will be described.

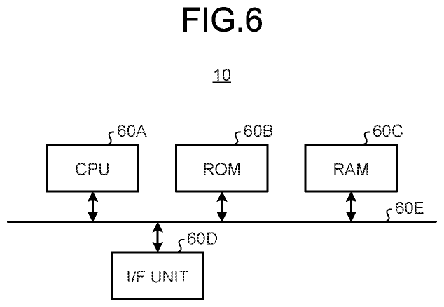

FIG. 6 is a hardware configuration diagram illustrating an example of the measurement device 10 according to the above embodiment.

The measurement device 10 of the above embodiment includes a control device such as a CPU 60A, a storage device such as a read only memory (ROM) 60B, a random access memory (RAM) 60C, and a hard disk drive (HDD), an I/F unit 60D that is an interface with various devices, and a bus 60E that connects the units and have a hardware configuration using a normal computer.

In the measurement device 10 of the above embodiment, the CPU 60A reads a program from the ROM 60B onto the RAM 60C and executes the program, whereby the above units are implemented on the computer.

Note that the program for executing each piece of the above processing executed in the measurement device 10 of the above embodiment may be stored in the HDD. Alternatively, the program for executing each piece of the above processing executed in the measurement device 10 of the above embodiment may be provided by being incorporated in the ROM 60B in advance.

Further alternatively, the program for executing each piece of the above processing executed in the measurement device 10 of the above embodiment may be stored as a file in an installable format or an executable format in a computer-readable storage medium such as a CD-ROM, a CD-R, a memory card, a digital versatile disk (DVD), or a flexible disk (FD) and provided as a computer program product. Moreover, the program for executing each piece of the above processing executed in the measurement device 10 of the above embodiment may be stored in a computer connected to a network such as the Internet and provided by being downloaded via the network. Furthermore, the program for executing each piece of the above processing executed in the measurement device 10 of the above embodiment may be provided or distributed via a network such as the Internet.

According to a measurement device, a measurement method, and a computer program product according to the present disclosure, it is possible to avoid contact between an antenna and a target to satisfactorily measure the communication performance of a communication system.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A measurement device comprising:
a memory; and
a processor coupled to the memory and configured to:
transmit a distance-detecting radiowave from an antenna;
detect a distance between the antenna and a target based on a first reception radiowave received by the antenna, the first reception radiowave being a reflected wave of the distance-detecting radiowave reflected by the target on which a communication system configured to transmit a measurement target radiowave is mounted;
perform drive control on at least one of the antenna and the target so that the detected distance reaches a set distance larger than 0; and
derive, when the detected distance reaches the set distance, communication performance of the communication system based on a second reception radiowave, the second reception radiowave being the measurement target radiowave received by the antenna.

2. The measurement device according to claim 1, wherein the processor is further configured to perform the drive control on at least one of the antenna and the target so that the detected distance reaches the set distance corresponding to a wireless communication scheme of the measurement target radiowave.

3. The measurement device according to claim 1, wherein the processor is further configured to stop the drive control of the antenna and the target when the detected distance is less than the set distance.

4. The measurement device according to claim 2, wherein the processor is further configured to stop the drive control of the antenna and the target when the detected distance is less than the set distance.

5. The measurement device according to claim 3, wherein the processor is further configured to perform, when the detected distance is less than the set distance, drive control on at least one of the antenna and the target so that the distance between the antenna and the target increases.

6. The measurement device according to claim 4, wherein the processor is further configured to perform, when the detected distance is less than the set distance, drive control on at least one of the antenna and the target so that the distance between the antenna and the target increases.

7. The measurement device according to claim 1, wherein the processor is further configured to perform, when the detected distance exceeds the set distance, the drive control on at least one of the antenna and the target so that the distance between the antenna and the target decreases.

8. The measurement device according to claim 2, wherein the processor is further configured to perform, when the detected distance exceeds the set distance, the drive control on at least one of the antenna and the target so that the distance between the antenna and the target decreases.

9. The measurement device according to claim 3, wherein the processor is further configured to perform, when the detected distance exceeds the set distance, the drive control on at least one of the antenna and the target so that the distance between the antenna and the target decreases.

10. The measurement device according to claim 4, wherein the processor is further configured to perform, when the detected distance exceeds the set distance, the drive control on at least one of the antenna and the target so that the distance between the antenna and the target decreases.

11. The measurement device according to claim 5, wherein the processor is further configured to perform, when the detected distance exceeds the set distance, the drive control on at least one of the antenna and the target so that the distance between the antenna and the target decreases.

12. The measurement device according to claim 6, wherein the processor is further configured to perform, when the detected distance exceeds the set distance, the drive control on at least one of the antenna and the target so that the distance between the antenna and the target decreases.

13. A measurement method comprising:
transmitting a distance-detecting radiowave from an antenna;
detecting a distance between the antenna and a target based on a first reception radiowave received by the antenna, the first reception radiowave being a reflected wave of the distance-detecting radiowave reflected by the target on which a communication system configured to transmit a measurement target radiowave is mounted;
performing drive control on at least one of the antenna and the target so that the detected distance reaches a set distance larger than 0; and
deriving, when the detected distance reaches the set distance, communication performance of the communication system based on a second reception radiowave, the second reception radiowave being the measurement target radiowave received by the antenna.

14. The measurement method according to claim 13, wherein the performing includes performing the drive control on at least one of the antenna and the target so that the detected distance reaches the set distance corresponding to a wireless communication scheme of the measurement target radiowave.

15. The measurement method according to claim 13, wherein the performing includes stopping the drive control of the antenna and the target when the detected distance is less than the set distance.

16. The measurement method according to claim 15, wherein the performing includes performing, when the detected distance is less than the set distance, drive control on at least one of the antenna and the target so that the distance between the antenna and the target increases.

17. The measurement method according to claim 13, wherein the performing includes performing, when the detected distance exceeds the set distance, the drive control on at least one of the antenna and the target so that the distance between the antenna and the target decreases.

18. A computer program product including programmed instructions embodied in and stored on a non-transitory computer readable medium, wherein the instructions, when executed by a computer, cause the computer to perform:
transmitting a distance-detecting radiowave from an antenna;
detecting a distance between the antenna and a target based on a first reception radiowave received by the antenna, the first reception radiowave being a reflected wave of the distance-detecting radiowave reflected by the target on which a communication system configured to transmit a measurement target radiowave is mounted;
performing drive control on at least one of the antenna and the target so that the detected distance reaches a set distance larger than 0; and
deriving, when the detected distance reaches the set distance, communication performance of the communication system based on a second reception radiowave, the second reception radiowave being the measurement target radiowave received by the antenna.
